(19) United States
(12) Patent Application Publication
(10) Pub. No.: US 2006/0259358 A1
(43) Pub. Date: Nov. 16, 2006

(54) Grocery scoring

(75) Inventors: Andrew Robinson, Apple Valley, MN (US); Bill Adam, Sandy Hook, CT (US)

Correspondence Address: FOGG AND ASSOCIATES, LLC, P.O. BOX 581339, MINNEAPOLIS, MN, 55458-1339, US

(73) Assignee: HomeTown Info, Inc., Minneapolis, MN (US)

(21) Appl. No.: 11/130,012

(22) Filed: May 16, 2005

(51) Int. Cl. G06Q 30/00

(52) U.S. Cl. 705/14

(57) ABSTRACT

Providing product information to a consumer based on the likelihood the consumer will purchase the product. In one embodiment, a method recognizes a consumer. A data scoring algorithm is applied to sale products based on the shopping history of the consumer. The scoring algorithm is adapted to determine the likelihood of the consumer to purchase the sale items and display select sale products based on the data scoring algorithm.

### TECHNICAL FIELD

The present invention relates generally to providing information to a consumer and in particular providing product information to a consumer based on the likelihood the consumer will purchase the product.

### BACKGROUND

The ability to obtain information in fast and efficient manner is of great benefit in today's society. It is common to find all adults of a household working outside of the home to make ends meet. This does not leave much time to do the shopping or preparing food for the family. The use of personal computers and the internet has greatly increased the efficiency of modern day life. For example, the internet can be used to conduct research on recipes and can be used even to view store inventories and store specials. Moreover, stores may e-mail periodic circular ads that describe the items they have on sale to a consumer. Screen displays such as Graphical User Interfaces (GUIs) indicating a store's items can be very helpful for the consumer.

Providing an on line circular ad to a consumer may not produce the desired results if the consumer does not have the time to scroll through numerous ads to find select items that he or she would like to purchase. A method of pin pointing items that a consumer is likely to buy is desired in the art.

For the reasons stated above and for other reasons stated below which will become apparent to those skilled in the art upon reading and understanding the present specification, there is a need in the art for an efficient method of determining items likely to be purchased by a consumer.

### SUMMARY

The above-mentioned problems and other problems are resolved by the present invention and will be understood by reading and studying the following specification.

In one embodiment, a method of customizing display ads for select consumers is provided. The method comprises recognizing a consumer. Applying a data scoring algorithm to sale products based on the shopping history of the consumer, the scoring algorithm being adapted to determine the likelihood of the consumer to purchase the sale items and displaying select sale products based on the data scoring algorithm.

In another embodiment, a method of displaying ads to a consumer is provided. The method includes identifying the shopping history of the consumer. Applying a data scoring algorithm to items for sale. The data scoring algorithm is adapted to score data related to each item for sale to determine if the consumer is likely to purchase the item. The scoring is based at least in part on exact matches, level of attribute matches, brand affinity and product location. The items for sale are then displayed to the consumer based on the data scoring algorithm.

In yet another embodiment, a data scoring method is provided. The method comprises determining if an item for sale is an exact match with an item in a consumers shopping history. When an exact match is determined, providing a highest score to the item for sale. Determining the number of attributes of an item for sale compared to items in the consumers shopping history. When the number of attributes are above a select number, providing a score that is less than the highest score of an exact match. Determining brand affinity between an item for sale and items in a consumer's shopping history. When the brand affinity of the item for sale matches the brand affinity of items in the past history, providing a score that is less than the score provided by a number of attributes match. Determining the product location of an item for sale and comparing the location to locations of items purchase in the consumer's shopping history and when the product location of an item for sale matches locations of items purchase in the consumer's shopping history, proving a score that is less than a score provided by a brand affinity comparison.

In still another embodiment, a computer-readable medium having computer-executable instructions for performing a method is provided. The method includes determining the shopping history of a consumer by tracking past purchases. Data scoring items for sale based on the shopping history of the consumer. The data scoring is based at least in part on at least one of exact matches, number of attribute matches, brand affinity and product location. The likelihood of the consumer purchasing the sale items based on the data scoring is then determined.

In still further another embodiment, a method of determining the likelihood of a consumer to purchase a product is provided. The method comprises a means for tracking the shopping history of a consumer. A means for scoring items for sale based on the shopping history of the consumer. The scoring is based on at least one of exact matches, number of attribute matches, brand affinity and product location. Also included is a means for determining the likelihood of the purchase of the item by the consumer based on the scoring of the items.

In finally another embodiment, a method of determining the likelihood of a consumer to purchase a product is provided. The method comprises creating a library of products cataloged by product location in a store. Tracking the purchase history of a consumer and evaluating items for sale to determine if any of the items for sale have a similar product location as products tracked in the purchase history of the consumer.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a flow diagram of one embodiment of the present invention;

FIG. 2, is a screen shot of one embodiment of the present invention; and

FIG. 3, is a flow diagram of a level of data scoring of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of embodiments of the present invention, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide an efficient method of determining what products or items a consumer is likely to purchase based on the consumers purchase history. Embodiments of the present invention use that information to provide product specific ads to the consumer.

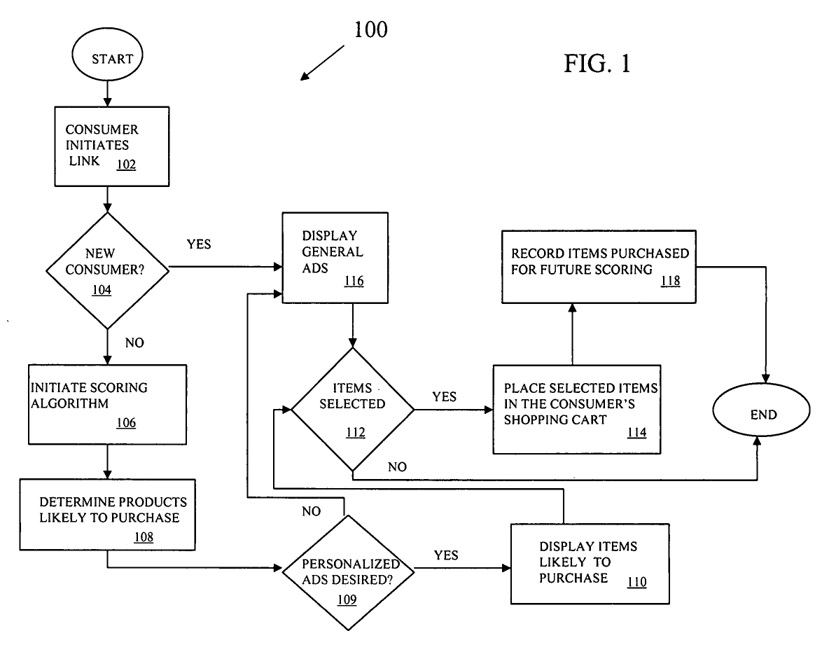

Referring to FIG. 1, a flow diagram 100 of one embodiment of the present invention is illustrated. As illustrates, in this embodiment, the process is started by the consumer establishing a link to the retailer's web cite (102). The link may be through an internet or intranet connection or the like. In this embodiment, it is then determined if the consumer is a new consumer without a purchase history or a returning consumer with a purchase history (or profile) (104). If the consumer is new (104), general ads displaying items for sale are provided by a graphic user interface (GUI) screen (or display screen) (116). If an item in the ad is selected 112, the item is placed in an on line consumer specific shopping cart for purchase (114). The item is then recorded as part of a purchase history for the consumers (118). The purchase history used to score future sale items. That is, the recording of the purchased product will be used to create a profile of the consumer that will be used in scoring items the consumer is likely to purchase in the future.

If it is determined that the customer has a purchase history (104), a scoring algorithm is initiated (106). The scoring algorithm takes into consider factors such as frequency of purchase of select items, comparable items, etc. The products the customer are likely to purchase are then determined by the scoring algorithm (108). In one embodiment, the higher the score, the more likely the consumer is to buy a product. Further, in one embodiment, the consumer is given the option to see the ads personalized based on the scoring algorithm (109). If the consumer decides not to see the personalized ads (109), the non specific generalized ads are displayed (116). If the consumer decides to view the personalized ads (109), the ads are displayed (110). In embodiments of the present invention, the retailer determines which ads are to be displayed. For example, if the retailer is overstocked on a particular brand item and that item is an item that scored high but under a different brand, the retailer may select to substitute the brand with the overstocked brand item. If the item is not selected for purchase (112), the process ends. If the item is then selected for purchase 112, it is placed in the consumers shopping cart (114). The item is then recorded for future use in the scoring algorithm when the consumer re-visits the retailer's web cite 116.

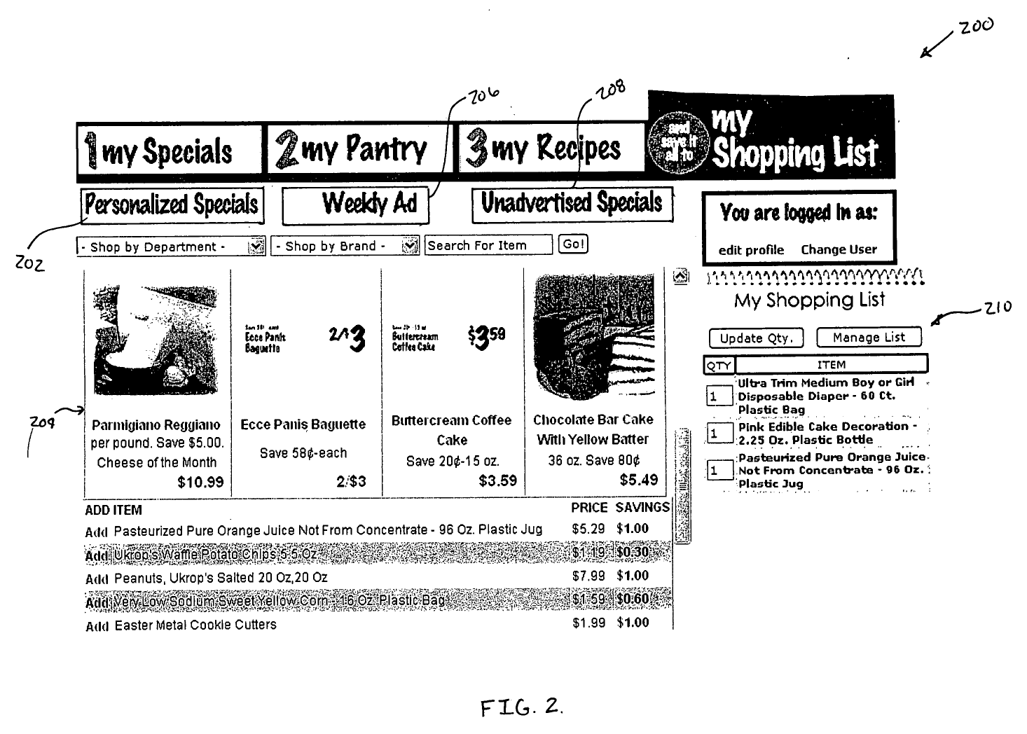

Referring to FIG. 2, an example of a GUI (or screen shot of a GUI or display) 200 is illustrated. The screen shot of an ad circular 200 illustrates one embodiment of present invention. In this embodiment, the consumer is given the option to select personalized specials 202, weekly ad 206 or unadvertised specials 208. If the personalized specials link 202 is activated, a scoring algorithm is initiated that determines which products on special are the products the consumer is likely to buy based on past purchase history. The products 204 that score the highest are then displayed. In this embodiment, a customer shopping list 210 is also provided for the consumer. Although this embodiment is illustrated using grocery products, the present invention is not limited to such products. In fact, one skilled in the art will understand that the present invention can be applied to any type of product being displayed for sale via a computer display screen.

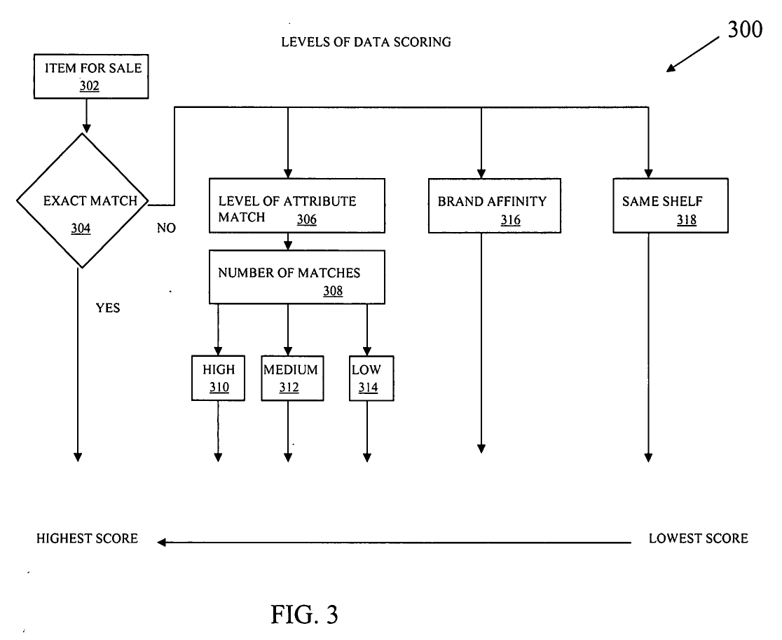

FIG. 3, illustrates one embodiment of a scoring flow diagram 300 of the present invention. As discussed above, the score is a rank of product relevancy. In the embodiment illustrated in FIG. 3, the higher the ranked score, the more relevant a sale product is to the consumer or household. Moreover, in the embodiment of FIG. 3, four levels of data scoring in order of decreasing relevancy from left to right is provided. In this embodiment each item for sale is considered in turn against the consumer's purchase history (302). If there is an exact match (304), the highest possible score is provided. One method of determining if an exact match is present is by comparing UPC codes. If there is not an exact match (304), other levels of data scoring are considered.

The next level of data scoring considered is the level of attribute match (306). The level of attribute match (306) provides a ranking based on number of matches of attributes (308). In the illustrated embodiment of FIG. 3, three ranking levels high (310), medium (312) and low (314) are used. Examples of attributes of an item include product type, color, flavor, size, packaging, ingredients, style, etc. In one embodiment, a sale item or product with 5 possible attributes is considered high (310), a sale item with at least 3 like attributes is considered medium (312) and a sale item with at least two attributes is considered low (314). As illustrated in FIG. 3, the high ranking level (310) provides a higher data score than the medium ranking level (312) and the medium ranking level provides a higher score than the low ranking level (314).

The next level of data scoring is the brand affinity (316). The brand affinity data scoring determines if the sale item or product is of the same brand of items in a consumer's purchase history. These would be items having a different UPC than the sale item. As illustrated in FIG. 3, the scoring in this level is less than the scoring in the level of attribute match. The next level of data scoring is the same shelf (318) or product location (318). In this data scoring level, a library (database) of products are cataloged by location parameters such as department, aisle, category, shelf, etc. A consumer's past history is reviewed to determine if the sale item is associated with the parameters of the same shelf data scoring. For example, if a sale item has the same or similar location parameters of department=grocery, aisle=baby, category=baby food and shelf=organic baby food, then the sale item would be scored at this level.

Once the levels of scoring the items for sale have been conducted, the consumer is presented the sale items according to the scoring. In one embodiment, the item or items are displayed in order of highest to lowest. In another embodiment, only the items with a select scoring level are displayed.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory previously or now known or later developed, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and DVD disks. Any of the foregoing may be supplemented by, or incorporated in, specially-designed application-specific integrated circuits (ASICs).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. For example, although, the above invention is illustrated in relation to grocery items, the same process can be used for any product for sale. Therefore, it is manifestly intended that this invention be limited only by the claims and the equivalents thereof.

1. A method of customizing display ads for select consumers, the method comprising:
recognizing a consumer;
applying a data scoring algorithm to sale products based on the shopping history of the consumer, the scoring algorithm being adapted to determine the likelihood of the consumer to purchase the sale items; and
displaying select sale products based on the data scoring algorithm.

2. The method of claim 1, wherein applying the data scoring algorithm further comprises:
determining levels of data scoring.

3. The method of claim 2, wherein the displaying select items further comprises:
displaying the select items that score the highest in the data scoring.

4. The method of claim 2, wherein determining the levels of data scoring includes considering at least one of exact match, level of attribute match, brand affinity and same shelf.

5. The method of claim 4, wherein the level of attribute match further comprises:
sorting the level of data scoring based on the number of matching attributes.

6. The method of claim 4, wherein the same self further comprises:
comparing location parameters of the sale item to location parameters of items in the consumer's shopping history.

7. The method of claim 1, further comprising:
recording purchases of items by the consumer; and
placing the items purchased in the shopping history of the consumer.

8. The method of claim 1, further comprising:
determining if the consumer wants the customized sale ads displayed.

9. A method of providing display ads to a consumer, the method providing:
identifying the shopping history of the consumer;
applying a data scoring algorithm to items for sale, the data scoring algorithm being adapted to score data related to each item for sale to determine if the consumer is likely to purchase the item, the scoring based at least in part on exact matches, level of attribute matches, brand affinity and product location; and
displaying items for sale to the consumer based on the data scoring algorithm.

10. The method of claim 9, wherein exact matches further comprises:
matching UPC code of the sale item to the UPC code of an item in the consumer's shopping history.

11. The method of claim 9, wherein brand affinity further comprises:
matching brand names of the sale item to the brand name of an item in the consumer's shopping history.

12. The method of claim 9, wherein the product location further comprises:
comparing location parameters of the sale item to location parameters of items in the consumer's shopping history.

13. The method of claim 9, wherein the level of attribute match further comprises:
sorting the level of data scoring based on the number of matching attributes.

14. The method of claim 1, wherein the matching attributes includes at least one of type of product, color, flavor, size, packaging and ingredients.

15. A data scoring method, the method comprising:
determining if an item for sale is an exact match with an item in a consumers shopping history;
when an exact match is determined, providing a highest score to the item for sale;
determining the number of attributes of an item for sale compared to items in the consumers shopping history;
when the number of attributes are above a select number, providing a score that is less than the highest score of an exact match;
determining brand affinity between an item for sale and items in a consumer's shopping history;
when the brand affinity of the item for sale matches the brand affinity of items in the past history, providing a score that is less than the score provided by a number of attributes match;
determining the product location of an item for sale and comparing the location to locations of items purchase in the consumer's shopping history; and
when the product location of an item for sale matches locations of items purchase in the consumer's shopping history, proving a score that is less than a score provided by a brand affinity comparison.

16. The method of claim 15, wherein an exact match further comprises:
matching a UPC code of the sale item to a UPC code of an item in the consumer's shopping history.

17. The method of claim 15, wherein matching brand affinity further comprises:
matching a brand name of the sale item to a brand name of an item in the consumer's shopping history.

18. The method of claim 15, wherein the comparing product location further comprises:
comparing location parameters of the sale item to location parameters of items in the consumer's shopping history.

19. The method of claim 18, wherein the location parameters include at least one of department, aisle, category and shelf.

20. The method of claim 15, wherein scoring based on the matching of attributes further comprises:
determining the level of scoring based on the number of matching attributes, wherein a high number of matching attributes corresponds to a higher scoring and a lower number of matching attributes corresponds to a lower scoring.

21. The method of claim 20, wherein the attributes includes at least one of type of product, color, flavor, size, packaging and ingredients.

22. A computer-readable medium having computer-executable instructions for performing a method comprising:
determining the shopping history of a consumer by tracking past purchases;
data scoring items for sale based on the shopping history of the consumer, the data scoring based at least in part on at least one of exact matches, number of attribute matches, brand affinity and product location; and
determining the likelihood of the consumer purchasing the sale items based on the data scoring.

23. The computer-executable instructions for performing a method of claim 22, further comprising:
displaying items for sale based on the determined likelihood the consumer purchasing the items for sale.

24. The method of claim 22, wherein an exact match further comprises:
matching a UPC code of the sale item to a UPC code of an item in the consumer's shopping history.

25. The method of claim 22, wherein brand affinity further comprises:
matching a brand name of the sale item to a brand name of an item in the consumer's shopping history.

26. The method of claim 22, wherein product location further comprises:
comparing location parameters of the sale item to location parameters of items in the consumer's shopping history.

27. The method of claim 22, wherein number of attribute matches further comprises:
determining the level of scoring based on the number of matching attributes, wherein a high number of matching attributes corresponds to a higher scoring and a lower number of matching attributes corresponds to a lower scoring.

28. A method of determining the likelihood of a consumer to purchase a product, the method comprising:
a means for tracking the shopping history of a consumer;
a means for scoring items for sale based on the shopping history of the consumer, wherein the scoring is based on at least one of exact matches, number of attribute matches, brand affinity and product location; and
a means for determining the likelihood of the purchase of the item by the consumer based on the scoring of the items.

29. A method of determining the likelihood of a consumer to purchase a product, the method comprising:
creating a library of products cataloged by product location in a store;
tracking the purchase history of a consumer; and
evaluating items for sale to determine if any of the items for sale have a similar product location as products tracked in the purchase history of the consumer.

30. The method of claim 29, further comprising:
displaying sale items with similar product locations based on the evaluation.

31. The method of claim 29, wherein the product location includes at least one of department, aisle, category and shelf.
